(19) United States
(12) Patent Application Publication
(10) Pub. No.: US 2011/0210720 A1
(43) Pub. Date: Sep. 1, 2011

(54) ALIGNMENT SYSTEM

(75) Inventor: John Joseph Corry, Cheshire (GB)

(73) Assignee: ADVANCED ANALYSIS AND INTEGRATION LIMITED, Manchester (GB)

(21) Appl. No.: 13/127,998

(22) PCT Filed: Nov. 9, 2009
(86) PCT No.: PCT/GB09/02636

§ 371 Date: May 11, 2011

(30) Foreign Application Priority Data
Nov. 7, 2008 (GB) 0820405.9

(51) Int. Cl. G01B 7/14

(52) U.S. Cl. 324/207.13

(57) ABSTRACT

A magnetic hole finder arrangement having a test field detector including a GMR sensor and may having a test field detector including a first and second magnetic field detectors (which may be GMRs) arranged with respect to a hole location position, the detectors having magnetic axes each arranged transversely to a radius from the hole location position to the detector. The arrangement may include geomagnetic or ambient magnetic field compensation.

This invention relates to alignment systems, especially, but not exclusively, systems for locating a hole in a support beneath a skin or cladding to drill therethrough from the side opposite the support to facilitate riveting the skin to the support, as, more particularly, in aircraft construction.

Alignment is at present effected magnetically. One pole of a magnet the field of which is aligned with the hole is placed beneath the hole so as to generate a test field of which field lines extend through the hole, and, of course, through the skin, and a field detector is placed on the skin and positioned to maximise the detected field.

WO2004/016380 and U.S. Pat. No. 6,927,560 disclose arrangements in which an array of Hall effect devices senses the test field at the skin and the outputs of the devices are analysed to provide an indication of the displacement of the array relative to the hole, so that the array can be moved to minimise the indicated displacement whereby to align the array with the hole.

Symmetric arrays of three up to sixteen Hall effect devices are described, more devices supposedly giving greater accuracy.

The arrangements are moved over the skin surface until the underlying hole is located, then clamped, as by suction, to serve as a drill guide.

Such arrangements are claimed to be able to locate the centres of holes with a typical accuracy of ±0.5 mm at hole depths of up to 22 mm with a 10 mm target—that is to say, a 10 mm diameter magnet pole. Accuracy is somewhat less at greater depths. For greater depths, stronger, and therefore, larger magnets are used. However, as no account is taken of the geomagnetic field and anomalies due to local magnetic materials, these arrangements can never achieve perfect alignment. Also, because different magnets are used for different depths of hole, there is always the possibility that the wrong magnet will be selected by an operator, and this may give rise to a gross error, which will be undetected until a hole has been drilled.

The present invention provides alignment systems, including hole finder arrangements that are capable of substantially greater accuracy.

The invention broadly comprises an alignment system comprising a test field generator generating a magnetic test field which is small in comparison to ambient magnetic fields and a sensor arrangement adapted to detect the magnetic test field with ambient field compensation.

The expression ‘magnetic test field’ as used herein encompasses both purely magnetic fields and electromagnetic fields.

The test field generator may comprise a magnet, and the sensor arrangement may then comprise GMR sensor means.

A GMR, or Giant MagnetoResistance, sensor is a device using thin films of magnetic and non-magnetic materials that changes its resistance markedly when subject to a magnetic field. Materials exhibiting magneto resistance, a change in electrical resistance due to a magnetic field, have been known for many years, but the effect has been quite small, and Hall effect devices have been the detector of choice in hole finder arrangements. The GMR device, however, can be used to make smaller, more sensitive, and therefore more accurate alignment devices.

Included within the term Giant MagnetoResistance, as used herein, are even more powerful devices of the same general nature, such as Colossal MagnetoResistance sensors, or CMRs.

The invention, in another aspect, comprises an alignment system comprising a magnetic test field generator and a magnetic test field detector comprising first and second magnetic field detectors having transverse axes each arranged to pass through an alignment position.

Their transverse axes may be orthogonal.

By ‘transverse axis’ is meant an axis transverse to the detection axis—the axis along which a magnetic field is detected—such that magnetic field aligned with the transverse axis gives a zero signal.

This arrangement of the sensors means that when the system is aligned—in a hole detector, when the alignment position is aligned with the hole position—they each give zero signals. A magnetic field from a magnet whose magnetic axis is aligned with a hole that is to be located generates a field which follows the familiar pattern in which the field lines form loops extending from one pole to the other. The sensors, displaced from the hole axis, intercept field lines which are bent away from the hole axis at substantially 90°—if the hole is vertical, the field lines where they intercept the sensors are substantially horizontal.

Particularly when the sensors are GMRs, the sensitivity of the arrangement is substantially better than prior art sensor arrangements. The sensitivity is such that they are sensitive to fields much smaller than ambient fields, in particular the geomagnetic field (between about 0.3 and 0.6 gauss, depending on location) but also stray fields from nearby magnetic items. With prior art Hall effect device sensors, large magnetic test fields are used rendering the effect of ambient fields negligible. With GMRs, test fields can be used, on the other hand, that are small compared to ambient fields, absent ambient field compensation.

While ambient field compensation can be effected when the test field is constant, as by a permanent magnet, it is preferred to use a varying test field, generated by an electromagnet that is switched on and off. The magnet may be continuously switched during a measurement, with an asymmetric mark-space ratio. The ambient field, when the magnet is off, will be aligned with one, at most, of the sensors, usually neither of them, and so will generate signals from the sensors which will be proportional to the components of the ambient field aligned with the sensors. When the magnet is on, its field will change the resistances of the sensors and alter the signal from each unless its transverse axis is aligned with the field lines. When the system is aligned, the magnet contributes nothing to the signal from either sensor and the system is confirmed to be aligned when there is no difference in the signals whether the magnet is on or off. If the system is roughly aligned to begin with, it is only necessary to adjust its position slightly until alignment is confirmed. The magnet may be switched on and off continually during the measurement, so that the geomagnetic field compensation is continuous.

The system may comprise indicator means indicating the direction in which it must be adjusted to reach alignment. The indicator means may comprise lamps arranged at ‘compass’ points. Adjacent lamps lit means adjust position in a direction between them, one lamp lit means adjust in its direction. While “all lamps out” could confirm alignment, it is preferred to have a positive indication, and, when close to alignment, the lamps can change colour, e.g. from red to green, and final adjustment confirmed when all lamps are lit. When this colour change is effected, the directional algorithms are reversed—movement is indicated towards unlit lamps.

The arrangement may also comprise a third magnetic field detector whose magnetic axis is orthogonal to the magnetic axes of the first and second detectors. The magnetic axis of the third detector may pass through the intersection of perpendiculars to the magnetic axes of the first and second detectors, unless the system is to be used as a drill guide, when it may be offset to allow drill access. The third detector may be used roughly to locate the hole when it detects a field aligned with the magnet. Adjustment, then, of the position of the arrangement so as to zero the fields detected by the first and second detectors will precisely locate the hole. Signal from this third magnet can be used to effect the colour change and algorithm reversal referred to above.

An additional strategy can be adopted to correct for thermal or other internal drift in the electronics. The magnet polarity can be reversed, and again this can be done continuously during the measurement. Drift in the electronics will show create opposite offsets with opposite polarity that can be cancelled electronically.

GMR detectors can be packaged, with a battery power supply, which may be rechargeable, in an easily manageable casing of roughly 200×100×10 mm. The test field may be provided by an electromagnet, which, since it does not need to be powerful, may require only a small battery power supply, making for an easily portable and usable instrument. The electromagnet may be comprised in a small package together with a battery and a switching circuit. The arrangement can be intrinsically safe, the detector arrangement being completely sealed in its casing, with no need of external cabling.

The casing may have attachment means adapted to attach it to the skin surface when it is centred over a hole, and may have a drill or marker guide aperture. The attachment means may comprise a suction arrangement.

The invention also comprises an alignment method comprising generating a magnetic test field which is small in comparison to ambient magnetic fields and sensing the magnetic test field with ambient field compensation.

The invention, in a more specific aspect, comprises a method for locating a hole in a support behind a skin comprising generating a test magnetic field of which field lines pass along the hole and through the skin, and detecting the field that passes through the skin using a field detector comprising first and second GMR detectors.

The method may include ambient field compensation. This may be effected by making a first measurement with no test field, so that only the ambient field is measured, and then a second measurement with the test field superimposed on the ambient field.

The test field may be switched on and off continuously during the location procedure so as to effect this compensation continuously during the measurement. The mark-space ratio may be asymmetric, to facilitate distinguishing between magnet-on and magnet-off signals.

The method may include a preliminary step of roughly locating the hole by adjusting the position of the arrangement over a supposed hole position until a maximum signal is obtained from a third magnetic field detector adapted to detect the test field aligned with the hole. The position of the arrangement may then be further finely adjusted until the difference in the signals from the first and second detectors is zero. A geomagnetic compensation step may precede or follow the preliminary step. Such compensation can, however, be continuously effected during the measurement process by switching the magnet on and off.

The method may then include the further step of locking the arrangement in place to allow it to be used as a drill or marker guide for drilling through the skin. Locking may be by a suction cup arrangement. When used as a drill guide, the third detector should be offset to permit drill access.

Alignment methods and arrangements according to the invention facilitate inter alia the speedier and more accurate location of holes for drilling purposes. Particularly in aircraft construction, where many rivets are used to attach a skin to a frame, the arrangement is substantially lighter and smaller, because of the reduced power requirements and the reduction in the number of components, than prior art arrangements, and this facilitates deployment and reduces the time required for the accurate location of holes, and increases the rates of production of aircraft components as well as enabling design optimisation because of the improved accuracy of hole location. Where damaged skin panelling has to be replaced, after a ground collision, perhaps, or in flight damage from a bird strike or hail, the improved accuracy of location extends the life of the frame to which the skin has to be attached by not having to increase the bore of the frame hole too much due to incorrect alignment.

Hole finder methods and arrangements according to the invention will now be described with reference to the accompanying drawings, in which:

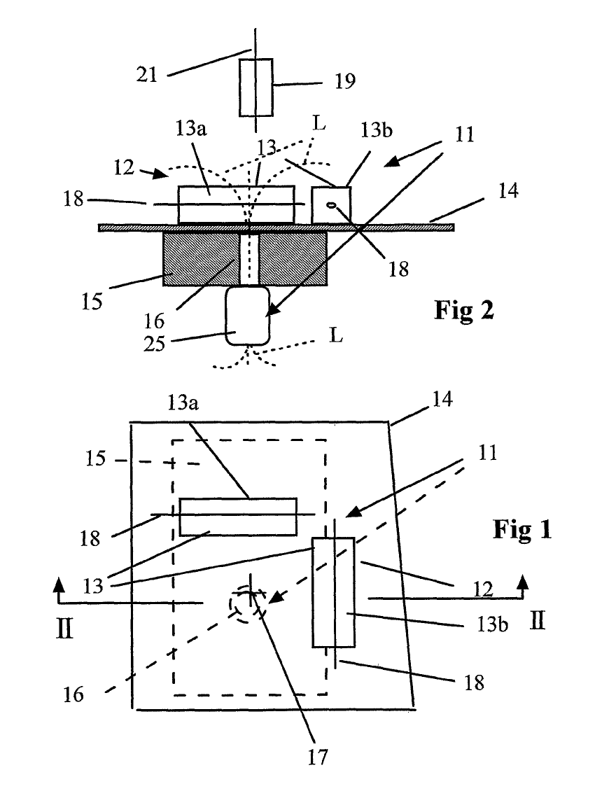

FIG. 1 is a diagrammatic plan view of one arrangement configured as a hole finder; and

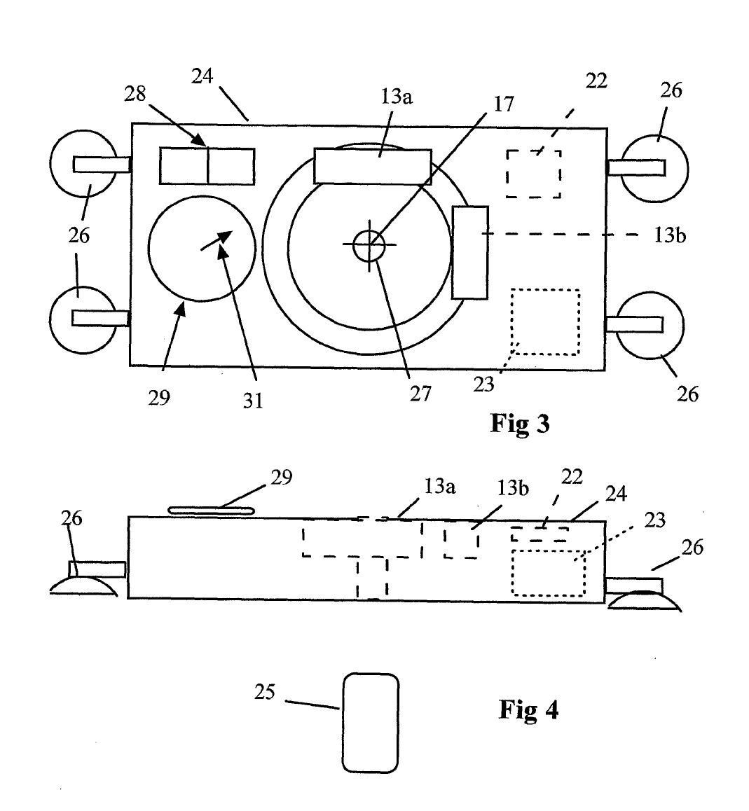

FIG. 2 is a part sectional view on the line II-II of FIG. 1, showing the hole finder on a skin that has to be riveted to a drilled frame member.

The drawings illustrate an alignment system 11 comprising a test field generator 12 (FIG. 2) generating a magnetic test field that is small in comparison to ambient magnetic fields and a sensor arrangement 13 adapted to detect the magnetic test field with ambient field compensation.

The alignment system 11 is configured as a hole finder, adapted to locate a hole 14 in a frame member 15 beneath a skin 16 which is to be attached thereto by rivets. It is required to drill a hole through the skin 16 in precise alignment with the hole 14. The sensor arrangement 13 then comprises a test field detector comprising GMR sensors 17. The arrangement 13 is deployed on the skin 16 roughly above where the hole 14 is expected to be. The test field is generated by the field generator 12, which is placed at the bottom of the hole 14 so that its field lines L are directed through the hole 14 and through the skin 16 directly above.

The magnetic field lines follow the familiar pattern forming loops L extending from one pole P1 of the magnetic test field generator 12 to the other P2. Two GMR sensors 17a, 17b, displaced from the hole axis, intercept field lines where they are bent away from the hole axis at substantially 90°—if the hole 14 is vertical, the field lines where they intercept the sensors 17a, 17b are substantially horizontal, or at least have a substantial horizontal component.

The GMR, or Giant MagnetoResistance, sensors 17 are devices using thin films of magnetic and non-magnetic materials that change their resistance markedly when subject to a magnetic field. Materials exhibiting magneto resistance, a change in electrical resistance due to a magnetic field, have been known for many years, but the effect has been quite small, and Hall effect devices have been the detector of choice in hole finder arrangements. The GMR device, however, can be used to make smaller and more accurate finder devices than conventional Hall effect hole sensors.

The sensors 17 are arranged in a circular well 18 of a casing 19 that holds a power supply and electronic circuitry, not shown, that controls and interprets signals from the sensors 17. The sensors 17a, 17b are each arranged with their magnetic axes directed at right angles to the radius from the centre of the well 18, and at right angles to one another, so that, when the field lines are directed along the radius, there is no magnetic field along the magnetic axis, and the GMR device gives a zero reading. The GMRs are, of course, directional. Four light emitting diodes, or like indicators, 21 are arranged at cardinal points on the casing 20, and light up when there is a field along the axis of a corresponding GMR. If one indicator 21 is lit, movement of the casing 18 in the direction of the lit indicator brings it closer to the zero field position. If two are lit, movement of the casing first in one direction then the other can bring it to the position where no field is detected by either GMR, indicating that the device is centrally over the hole 14. Rather, however, than have all lights out indicating alignment, the lights are arranged to change colour, e.g. from red to green, when approximate alignment is detected, and to reverse their significance, indicating the arrangement is to be moved towards an unlit light. Four green lights then indicates perfect alignment.

This is what would happen in the absence of ambient magnetic fields. The GMRs 13, however, can detect far weaker fields than can the conventional Hall effect sensors, so that the geomagnetic field can assume an importance.

The arrangement is, however, compensated for the local geomagnetic field by a preliminary measurement in the absence of the test field. This may be simply effected by ‘swinging’ the arrangement 11 in the absence of the test field, to zero the difference in the fields measured by the first and second detectors. Once the arrangement 11 is correctly aligned, the test field is introduced by applying the magnet and the hole detection procedure completed. This means that the arrangement is immune to any anomalies in the geomagnetic field caused, for example, by nearby magnetic materials. However, from the preliminary measurement, a compensating bias could automatically be applied by software to a measurement when the test field is introduced, so that the arrangement 11 can be used in any position of alignment with respect to the geomagnetic field.

In the arrangement illustrated, this is effected by the field generator 12 being an electromagnet which is cycled on and off, so that the GMRs sense alternately the ambient field and the resultant of the ambient field and the applied field, from which the ambient field can be subtracted by the software. The two fields are readily distinguished by the mark/space ratio of the electromagnet being asymmetric.

The power requirements of the arrangement are substantially less than those needed by conventional Hall effect sensor-based arrangements, and the detectors 13, 19 are packaged, with a battery power supply 21 which is rechargeable, in the casing 20, which is easily manageable at roughly 200×100×10 mm.

The casing has attachment means, not shown, in the form of suction cups adapted to attach it to the skin surface when it is centred over a hole, and has a drill or marker guide aperture 22.

The arrangement also comprises a third magnetic field detector 23 whose magnetic axis 24 is orthogonal to the magnetic axes of the first and second detectors—where those axes might be labelled x and y axes, axis 24 would be the z axis. The field detector 23, which may be a Hall effect device, is offset from the drill guide aperture 22 to allow access for a drill. The third detector 23 may be used roughly to locate the hole 14 when it detects a maximum field that is stronger than fields detected by the GMR sensors 17. Adjustment, then, of the position of the arrangement 11 on the basis of signals from the GMR detectors will precisely locate the hole 14. Signals from the third detector 23 are used to effect the colour change and reversal of significance of thee leds 21 referred to above.

The test field generator 12 comprises a casing 12a with an internal solenoid and control circuitry for generating the mark/space feature, and a projecting pole P1 that fits into the hole 14 in the frame member—this may be made a push fit, so that no other support is necessary. In another arrangement, a single control box can have multiple solenoids with pole pieces, so that multiple holes 14 may be powered simultaneously, and the sensor arrangement 13 deployed to locate the multiple holes without having to relocate the fest field generator between holes.

1. An alignment system comprising a test field generator generating a magnetic test field that is small in comparison to ambient magnetic fields and a sensor arrangement adapted to detect the magnetic test field with ambient field compensation.

2. An alignment system according to claim 1, comprising a test field detector comprising GMR sensor means.

3. A magnetic hole finder arrangement comprising a test field detector comprising first and second magnetic field detectors arranged with respect to a hole location position, the detectors having magnetic axes each arranged transversely to a radius from the hole location position to the detector.

4. An arrangement according to claim 2, in which when the detectors are ‘centred’ on the hole position, they sense zero fields.

5. An arrangement according to claim 3, in which the detectors are GMRs.

6. An arrangement according to claim 3, comprising a third magnetic field detector whose magnetic axis is orthogonal to the magnetic axes of the first and second detectors.

7. An arrangement according to claim 6, in which the magnetic axis of the third detector is offset from the intersection of perpendiculars to the magnetic axes of the first and second detectors.

8. An arrangement according to claim 3, adapted to be compensated for the local geomagnetic field by a preliminary measurement in the absence of the test field.

9. An arrangement according to claim 8, in which geomagnetic compensation is effected by ‘swinging’ the arrangement in the absence of the test field, to zero the difference in the fields measured by the first and second detectors.

10. An arrangement according to claim 8, in which a compensating bias is automatically applied to a measurement when the test field is introduced, so that the arrangement can be used in any position of alignment with respect to the geomagnetic field.

11. An arrangement according to claim 1, in which the test field is provided by a permanent magnet.

12. An arrangement according to claim 1, in which the test field is provided by electromagnet.

13. An arrangement according to claim 12, in which the electromagnet is cycled on and off, and on and off signals from the detectors subtracted to compensate for ambient magnetic fields.

14. An arrangement according to claim 13, in which the mark/space ratio of the on/off cycling is asymmetric whereby on and off fields can be distinguished.

15. An arrangement according to claim 1, contained in a casing having attachment means adapted to attach it to a skin to be drilled when it is centred over a hole in a member behind the skin.

16. An arrangement according to claim 14, in which the attachment means comprise a suction arrangement.

17. An arrangement according to claim 13, in which casing has a drill or marker guide aperture.

18. An arrangement according to claim 1, comprising a visual display indicating fields detected by the detectors.

19. An arrangement according to claim 18, in which the visual display comprises indicators at cardinal points of the device.

20. A method for locating a hole in a support behind a skin comprising generating a test magnetic field of which field lines pass along the hole and through the skin, and detecting the field that passes through the skin using a field detector comprising GMR detectors.

21. A method according to claim 20, in which two GMR detectors are arranged with their magnetic axes at right angles.

22. A method according to claim 21, in which the hole is located when both GMR detectors give a zero signal indicating that magnetic field lines are at right angles to their magnetic axes.

23. A method according to claim 20, including the step of geomagnetic or ambient field compensation.

24. A method according to claim 23, in which geomagnetic compensation is effected by making a first measurement with no test field.

25. A method according to claim 24, in which the arrangement is rotated until the difference in signals from the first and second detectors is zero, and this alignment is maintained when the test field is applied.

26. A method according to claim 23, in which, with random alignment of the arrangement, the signals due to the geomagnetic field from the signals from the first and second detectors are subtracted from the signals measured when the test field is applied.

27. A method according to claim 23, in which the test field is cycled on and off.

28. A method according to claim 27, in which the mark/space ratio of the on/off cycling is asymmetric.

29. A method according to claim 20, including a preliminary step of roughly locating the hole by adjusting the position of the arrangement over a supposed hole position until a maximum signal is obtained from a magnetic field detector aligned to detect the test field aligned with the hole.

30. A method according to claim 20, including the further step of locking the arrangement in place to allow it to be used as a drill or marker guide for drilling through the skin.

31. A method according to claim 30, in which locking is effected by a suction cup arrangement.

32. A method according to claim 20, in which centring is confirmed by a visual display arrangement.

33. A method according to claim 32, in which the visual display arrangement indicates the direction in which the arrangement is to be adjusted to achieve centring.
